(19) United States
(12) Patent Application Publication
(10) Pub. No.: US 2023/0085943 A1
(43) Pub. Date: Mar. 23, 2023

(54) Ensuring Proactive Availability of Vehicles for Providing Connected Vehicle Services

(71) Applicant: International Business Machines Corporation, Armonk, NY (US)

(72) Inventors: Venkata Vara Prasad Karri, Visakhapatnam (IN); Saraswathi Sailaja Perumalla, Visakhapatnam (IN); Sri Harsha Varada, Vizianagaram (IN); Sarbajit K. Rakshit, Kolkata (IN)

(21) Appl. No.: 17/480,421

(22) Filed: Sep. 21, 2021

(51) Int. Cl. G06F 30/27; G06F 16/27

(52) U.S. Cl. CPC G06F 30/27; G06F 16/27; G05D 1/0291

(57) ABSTRACT

A mechanism is provided in a data processing system for proactive deployment of connected vehicles to a connected vehicle ecosystem based on computerized simulation and prediction of contextual situations in accordance with an illustrative embodiment. The mechanism collects real-world data from sensors in a connected vehicle ecosystem and simulates the connected vehicle ecosystem based on the real-world data and a simulation model data of the connected vehicle ecosystem. The mechanism predicts changes in contextual situations in the connected vehicle ecosystem that affect connected vehicle services provided in the connected vehicle ecosystem based on the simulation of the connected vehicle ecosystem, the real-world data, and the simulation model data. The mechanism identifies a minimum number of connected vehicles required to provide the connected vehicle services and deploys one or more additional connected vehicles to the connected vehicle ecosystem based on the predicted changes in contextual situations and the minimum number of connected vehicles required to provide the connected vehicle services.

### BACKGROUND

The present application relates generally to an improved data processing apparatus and method and more specifically to mechanisms for predicting possibilities of disruption in a connected vehicle ecosystem and proactively arranging a required number of vehicles to provide connected vehicle services without failure.

A connected vehicle is one that can connect over wireless networks to nearby devices. One of the primary use cases for connected vehicles is safety, via rapid vehicle-to-vehicle and vehicle-to-roadside unit communications.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided in a data processing system for proactive deployment of connected vehicles to a connected vehicle ecosystem based on computerized simulation and prediction of contextual situations in accordance with an illustrative embodiment. The method comprises collecting real-world data from sensors in a connected vehicle ecosystem. The method further comprises simulating the connected vehicle ecosystem based on the real-world data and simulation model data of the connected vehicle ecosystem. The method further comprises predicting changes in contextual situations in the connected vehicle ecosystem that affect connected vehicle services provided in the connected vehicle ecosystem based on the simulation of the connected vehicle ecosystem, the real-world data, and the simulation model data. The method further comprises identifying a minimum number of connected vehicles required to provide the connected vehicle services. The method further comprises deploying one or more additional connected vehicles to the connected vehicle ecosystem based on the predicted changes in contextual situations and the minimum number of connected vehicles required to provide the connected vehicle services.

In other illustrative embodiments, a computer program product comprising a computer useable or readable medium having a computer readable program is provided. The computer readable program, when executed on a computing device, causes the computing device to perform various ones of, and combinations of, the operations outlined above regarding the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above regarding the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system in which aspects of the illustrative embodiments may be implemented;

FIG. 2 is an example block diagram of a computing device in which aspects of the illustrative embodiments may be implemented;

FIGS. 3A-3C are block diagrams of a connected vehicle service provider system for proactive deployment of connected vehicles to a connected vehicle ecosystem based on computerized simulation and prediction of contextual situations in accordance with an illustrative embodiment;

FIG. 4 is a block diagram of a digital twin simulation and prediction engine in accordance with an illustrative embodiment;

FIG. 5 is a block diagram illustrating a digital twin architecture in accordance with an illustrative embodiment;

FIG. 6 is a flowchart illustrating operation of a connected vehicle service provider system for proactive deployment of connected vehicles to a connected vehicle ecosystem based on computerized simulation and prediction of contextual situations in accordance with an illustrative embodiment; and

FIG. 7 is a flowchart illustrating operation of a connected vehicle service provider system identifying a number and placement of additional vehicles required to maintain services in accordance with an illustrative embodiment.

### DETAILED DESCRIPTION

Connected vehicles are vehicles that use communication technologies to communicate with the driver, other cars on the road, roadside infrastructure, and the “Cloud.” This technology can be used to not only improve vehicle safety, but also to improve vehicle efficiency and commute times. Listed below are the types of communications, with links to more information, and some of the benefits of connected vehicles:

Vehicle to Infrastructure (V2I): This type of connectivity is used mainly for the safety of the vehicle. The vehicle communicates with the road infrastructure, and shares/receives information such as traffic/road/weather condition, speed limits, accidents, etc.

Vehicle to Vehicle (V2V): The vehicle-to-vehicle communication system allows the real-time exchange of information between vehicles. V2V is also used for the safety of vehicles.

Vehicle to Cloud (V2C): The V2C connection is established via a wireless network and relays data with the cloud. Vehicle to cloud connectivity is mainly used for downloading over-the-air (OTA) vehicle updates or remote vehicle diagnostics or to connect with any IoT devices.

Vehicle to Pedestrian (V2P): A V2P system is used for safety purposes. Vehicles use sensors to detect pedestrians, which gives collision warnings.

Vehicle to Everything (V2X): The combination of all the above-mentioned types of connectivity is known as V2X connectivity.

Connected vehicle systems can provide many services and features. The features of connected car technology improve the overall driving and ownership experience and add a safety net with advanced security features. Some example connected vehicle services and features are as follows:

Internet Connectivity in Cars: A connected car is always connected to the internet via an embedded chipset or subscriber identification module (SIM) card, and it can access the internet, provided there is stable wireless network coverage. Connected vehicles can also provide onboard WiFi connectivity, download over-the-air updates released by the manufacturer, and access other online apps and services.

App to Car Connectivity: Many car manufacturers provide a dedicated smartphone app that connects with the vehicle through the wireless network. The app allows users to remotely operate the functions of a car such as locking/unlocking the door, opening the sunroof, engine start/stop, climate control, headlight on/off, and honk the horn. The app will also help to locate the car via the onboard GPS.

Protecting Young Drivers: Some connected vehicles come with an important security feature known as Geo-Fencing, which creates a geographical boundary on a map and alerts the owner if the vehicle is driven beyond the set boundary. The geo-fencing can be set via the smartphone app, and this feature will be extremely useful if the owner is worried about young or inexperienced drivers taking the car out.

Vehicle to Vehicle Communication: Vehicle-to-vehicle connectivity technology allows connected vehicles to communicate with each other. The V2V enables sharing of vital information such as traffic movement, road conditions, speed limits, etc.

Entertainment: A connected vehicle may allow the driver to connect to pre-loaded entertainment services or applications. The driver can listen to music, internet radio, or even watch videos when the vehicle is parked. The driver can also connect a smartphone to the infotainment system of the car via apps and remotely control the audio/video.

Remote Parking: Some high-end connected cars even allow the driver to remotely park the vehicle. Using a smartphone app or a smart key fob, the driver can get out of the vehicle and maneuver the car to park it in a desired spot. This feature is useful in tight parking spaces or when the driver is not confident about parking the car in a very congested area.

Security: Many connected vehicles come equipped with several critical security features such as real-time location sharing/tracking, emergency SOS calls in case of an accident, roadside assistance in case of vehicle breakdown, etc.

Advanced Navigation: Connected vehicles can dynamically modify navigation routes based on changing road conditions, traffic, driver preferences, vehicle conditions (e.g., navigating past gas stations or charging stations), and the like.

Fleet Management: Connected vehicles can analyze vehicle data to improve fleet safety, fuel efficiency, and vehicle utilization and productivity.

User-Based Insurance: Connected vehicle systems can provide tracking of vehicles in case of theft and can record data to be used to settle insurance claims.

In various contextual situations, a single vehicle may not be able to provide required services to the driver or passengers. For example, there may be a cellular network outage in a particular area of a city or weather conditions may provide traffic congestion. Connected vehicles may use V2V connectivity to communicate data; however, there may be times when a distance between vehicles renders V2V communication unreliable or temporarily disrupted.

The illustrative embodiments provide a proactive connected vehicle deployment engine within a connected vehicle system that predicts possibilities of disruption where less than a threshold number of vehicles needed to provide a predetermined quality of connected vehicle service and proactively arranges a required number of vehicles to provide the connected vehicle service without failure. In one embodiment, the proactive connected vehicle deployment engine uses a digital twin simulation and prediction engine to simulate contextual situations and identify a minimum number of vehicles required to maintain agreed-upon connected vehicle services to drivers and passengers with the connected vehicle system. The proactive connected vehicle deployment engine proactively arranges deployment of additional vehicles at a relative position and distance required to provide the connected vehicle services.

In one example embodiment, the proactive connected vehicle deployment engine uses the digital twin simulation and prediction engine to predict if any vehicle is going to have a problem (e.g., a mechanical problem, low fuel, etc.) and a location of the vehicle problem. Accordingly, the proactive connected vehicle deployment engine then proactively arranges the deployment of an alternate vehicle for the driver or a passenger to use. For example, if a driver in a fleet of delivery vehicles breaks down, then the proactive connected vehicle deployment engine can predict this event and proactively provide a replacement vehicle so the deliveries can be completed. As another example, if a passenger in a ride sharing service gets stranded, the proactive connected vehicle deployment engine can predict this event and proactively deploy a replacement vehicle to minimize the disruption to the passenger.

The digital twin simulation and prediction engine gathers or collects information from every vehicle and other sources on a real-time basis and uses historical learning to predict contextual situations (e.g., bad weather, wireless network unavailability, poor road conditions, etc.). The proactive connected vehicle deployment engine then identifies an appropriate number of vehicles and corresponding routes to place the vehicles into the connected vehicle ecosystem to provide the agreed-upon connected vehicle services. With the correct timing and placement of additional vehicles, V2V connection between vehicles can be maintained without failure.

In one embodiment, the proactive connected vehicle deployment engine may use blockchain ledger to track whether any connected vehicle service is not satisfied and to track how connected vehicle services are provided to the passengers. The blockchain ledger can be used to enforce smart contracts to automatically execute, control, or document legally relevant events and actions according to the terms of a contract or an agreement between the connected vehicle services provider and the customers. The blockchain ledger can be used by computer-implemented smart contracts to reduce need for trusted intermediators, arbitrations and enforcement costs, fraud losses, as well as to reduce malicious and accidental exceptions. Connected vehicles may record connections to cellular network towers, other vehicles, or infrastructure to provide evidence of how connected vehicle services are delivered to the vehicles. Furthermore, the proactive connected vehicle deployment engine can record deployment of additional vehicles into the connected vehicle ecosystem or removal of vehicles from the connected vehicle ecosystem in the blockchain ledger to provide evidence of how the connected vehicle service provider satisfied the agreement.

Based on the digital twin simulation of connected vehicle services in different contextual situations, the proactive connected vehicle deployment engine proactively deploys vehicles in appropriate locations. When there is a need to include an additional vehicle, the proactive connected vehicle deployment engine can then activate the additional vehicles necessary to maintain vehicle connectivity. The additional vehicles may be any vehicles within the connected vehicle ecosystem, including passenger cars, vehicles within a fleet of service vehicles, self-driving cars, drones, etc.

Before beginning the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” regarding features and elements of the illustrative embodiments. It should be appreciated that these terms and phrases are intended to state that there is at least one feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein regarding describing embodiments and features of the invention, is not intended to be limiting of any implementation for accomplishing and/or performing the actions, steps, processes, etc., attributable to and/or performed by the engine. An engine may be, but is not limited to, software executing on computer hardware, specialized computer hardware and/or firmware, or any combination thereof that performs the specified functions including, but not limited to, any use of a general and/or specialized processor in combination with appropriate software loaded or stored in a machine readable memory and executed by the processor to thereby specifically configure the processor to perform the specific functions of the illustrative embodiments. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

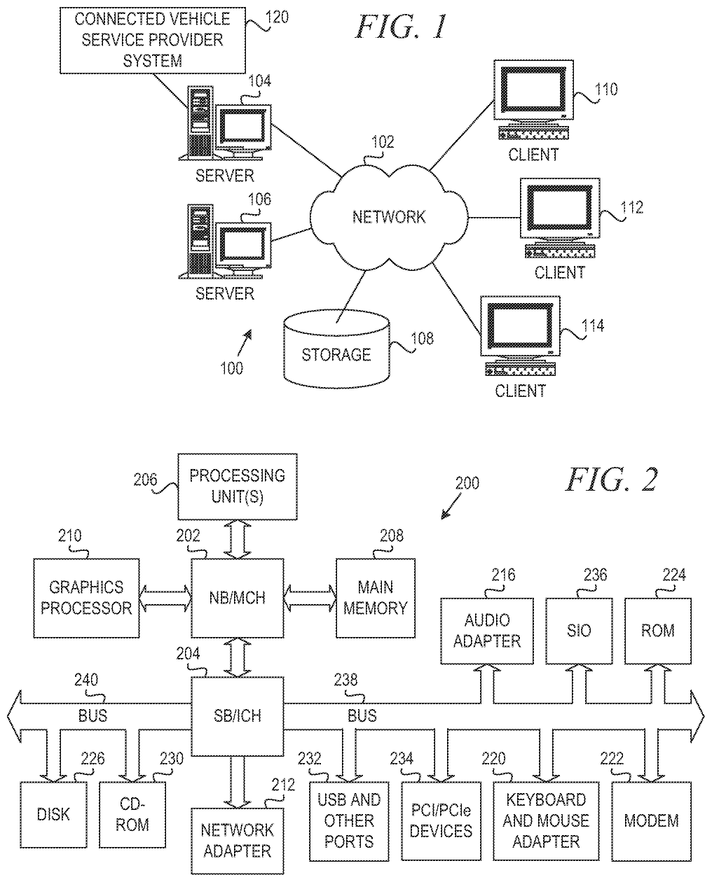

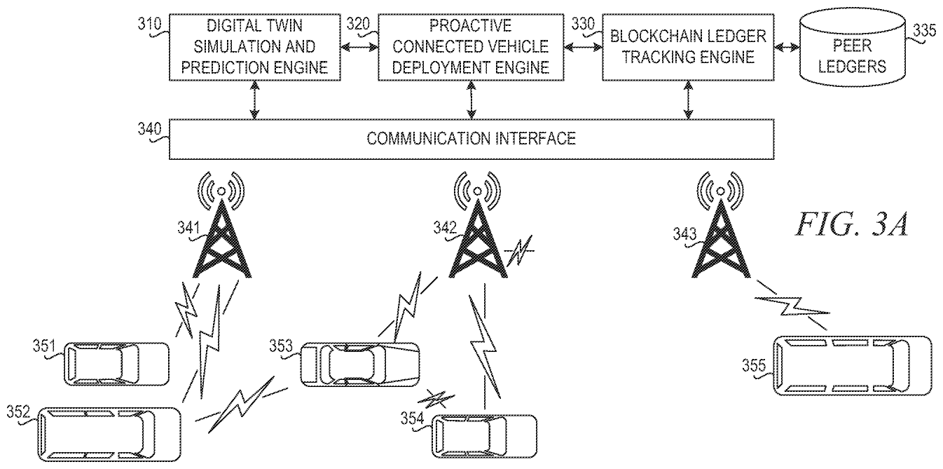

The illustrative embodiments may be utilized in many different types of data processing environments. To provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation regarding the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the distributed data processing system 100 may also be implemented to include different types of networks, such as for example, an intranet, a local area network (LAN), a wide area network (WAN), or the like. As stated above, FIG. 1 is intended as an example, not as an architectural limitation for different embodiments of the present invention, and therefore, the elements shown in FIG. 1 should not be considered limiting regarding the environments in which the illustrative embodiments of the present invention may be implemented.

As shown in FIG. 1, one or more of the computing devices, e.g., server 104, may be specifically configured to implement a connected vehicle service provider system 120. The configuring of the computing device may comprise the providing of application specific hardware, firmware, or the like to facilitate the performance of the operations and generation of the outputs described herein regarding the illustrative embodiments. The configuring of the computing device may also, or alternatively, comprise the providing of software applications stored in one or more storage devices and loaded into memory of a computing device, such as server 104, for causing one or more hardware processors of the computing device to execute the software applications that configure the processors to perform the operations and generate the outputs described herein regarding the illustrative embodiments. Moreover, any combination of application specific hardware, firmware, software applications executed on hardware, or the like, may be used without departing from the spirit and scope of the illustrative embodiments.

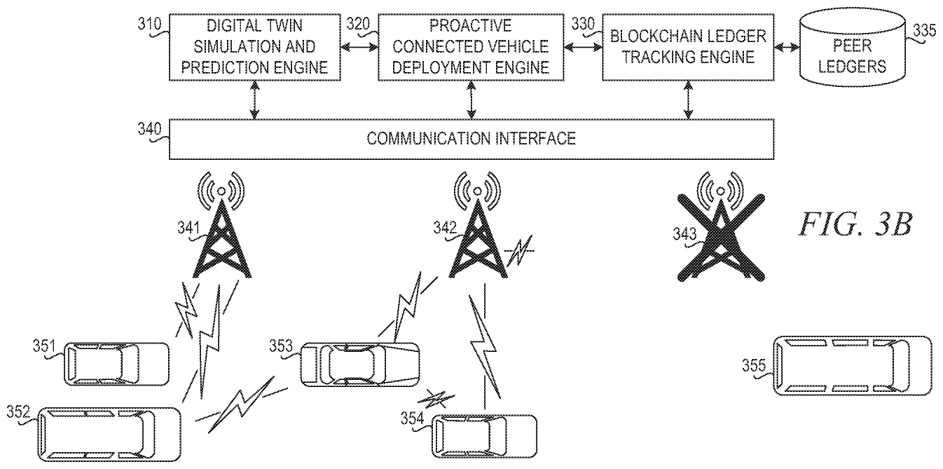

It should be appreciated that once the computing device is configured in one of these ways, the computing device becomes a specialized computing device specifically configured to implement the mechanisms of the illustrative embodiments and is not a general-purpose computing device. Moreover, as described hereafter, the implementation of the mechanisms of the illustrative embodiments improves the functionality of the computing device and provides a useful and concrete result that facilitates proactive deployment of connected vehicles to a connected vehicle ecosystem based on computerized simulation and prediction of contextual situations. The connected vehicle service provider system 120 is described in further detail below with reference to FIGS. 3-6.

As noted above, the mechanisms of the illustrative embodiments utilize specifically configured computing devices, or data processing systems, to perform the operations for proactive deployment of connected vehicles to a connected vehicle ecosystem based on computerized simulation and prediction of contextual situations. These computing devices, or data processing systems, may comprise various hardware elements which are specifically configured, either through hardware configuration, software configuration, or a combination of hardware and software configuration, to implement one or more of the systems/subsystems described herein. FIG. 2 is a block diagram of just one example data processing system in which aspects of the illustrative embodiments may be implemented. Data processing system 200 is an example of a computer, such as server 104 in FIG. 1, in which computer usable code or instructions implementing the processes and aspects of the illustrative embodiments of the present invention may be located and/or executed to achieve the operation, output, and external effects of the illustrative embodiments as described herein.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super 1/O (SIO) device 236 may be connected to SB/ICH 204.

An operating system runs on processing unit 206. The operating system coordinates and provides control of various components within the data processing system 200 in FIG. 2. In a client device, the operating system may be a commercially available operating system such as Microsoft® Windows®. An object-oriented programming system, such as the Java™ programming system, may run in conjunction with the operating system and provides calls to the operating system from Java™ programs or applications executing on data processing system 200.

As a server, data processing system 200 may be, for example, an IBM eServer™ System p® computer system, PowerJ processor-based computer system, or the like, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

As mentioned above, in some illustrative embodiments the mechanisms of the illustrative embodiments may be implemented as application specific hardware, firmware, or the like, application software stored in a storage device, such as HDD 226 and loaded into memory, such as main memory 208, for executed by one or more hardware processors, such as processing unit 206, or the like. As such, the computing device shown in FIG. 2 becomes specifically configured to implement the mechanisms of the illustrative embodiments and specifically configured to perform the operations and generate the outputs described hereafter regarding proactive deployment of connected vehicles to a connected vehicle ecosystem based on computerized simulation and prediction of contextual situations.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of various data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIGS. 3A-3C are block diagrams of a connected vehicle service provider system for proactive deployment of connected vehicles to a connected vehicle ecosystem based on computerized simulation and prediction of contextual situations in accordance with an illustrative embodiment. With reference to FIG. 3A, the connected vehicle service provider system comprises a digital twin simulation and prediction engine 310, a proactive connected vehicle deployment engine 320, and a blockchain ledger tracking engine 330. The connected vehicle service provider system provides connected vehicle services to vehicles 351-355 within a connected vehicle ecosystem. Connected vehicles 351-355 communicate with the connected vehicle service provider system via communication interface 340.

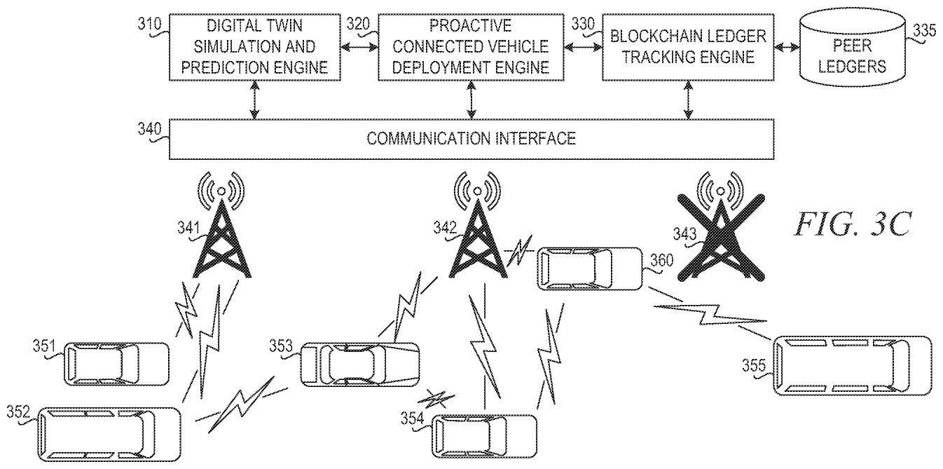

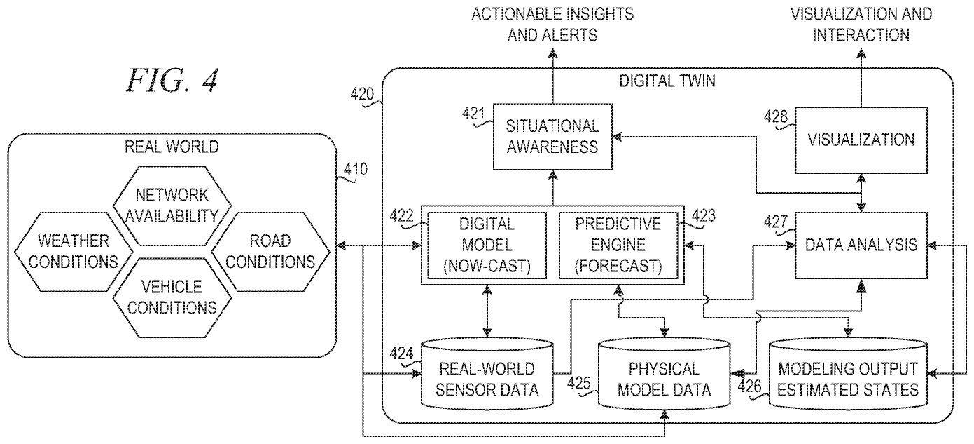

Digital twin simulation and prediction engine 310 simulates the services of connected vehicles in different contextual situations. A digital twin is a dynamic virtual representation of a physical object or system, usually across multiple stages of its lifecycle. It uses real-world data and simulation or machine learning models, combined with data analysis, to enable understanding, learning, and reasoning. Digital twins have one fundamental purpose: to model the behavior of real-world systems to enable better decisions that impact the real world. In the illustrative embodiment, digital twin simulation and prediction engine 310 receives real-world data and uses physical model data to model the connected vehicles in the ecosystem and to predict contextual situations that may affect vehicle connectivity. Digital twin simulation and prediction engine 310 will be described in further detail below with reference to FIGS. 4 and 5.

Based on the simulation and predictions from digital twin simulation and prediction engine 310, proactive connected vehicle deployment engine 320 determines when contextual situations will change, a degree of change, and when additional vehicles will be required to provide vehicle-to-vehicle (V2V) communication to provide the connected vehicle services. Proactive connected vehicle deployment engine 320 then determines a number of vehicles required to maintain connected vehicle services provided by the connected vehicle service provider. In addition, based on current locations of vehicles and direction and speed of motion, proactive connected vehicle deployment engine 320 determines when and where the additional connected vehicles will be required. Proactive connected vehicle deployment engine 320 deploys the additional connected vehicles to the determined locations to be activated proactively before the contextual situations change.

Proactive connected vehicle deployment engine 320 communicates with blockchain ledger tracking engine 330 to query peer ledgers 335. In one embodiment, the connected vehicle services are provided in accordance with a smart contract using blockchain ledgers 335 to record and audit information in a “compliance chain.” For example, some embodiments may use Hyperledger fabric and smart contracts to record connected vehicle services that were agreed upon, various connections that vehicles make (i.e., V2I, V2V, V2C, V2P, V2X), services that were provided, services that were not successfully provided, and actions taken by the connected vehicle provider to provide the services.

Hyperledger Fabric is a blockchain framework implementation and one of the Hyperledger projects hosted by The Linux Foundation. Intended as a foundation for developing applications or solutions with a modular architecture, Hyperledger Fabric allows components, such as consensus and membership services, to be plug-arid-play. Hyperledger Fabric leverages container technology to host smart contracts called “chaincode” that comprise the application logic of blockchain ledger tracking engine 330 in one embodiment. A smart contract is a computer protocol intended to digitally facilitate, verify, or enforce the negotiation or performance of a contract. Smart contracts allow the performance of credible transactions without third parties. These transactions are trackable and irreversible. Proponents of smart contracts claim that many kinds of contractual clauses may be made partially or fully self-executing, self-enforcing, or both. The aim of smart contracts is to provide security that is superior to traditional contract law and to reduce other transaction costs associated with contracting.

Connected vehicles 351-355 communicate with communication interface 340 via network towers 341-343. Network towers 341-343 may provide 4G (Fourth Generation), LTE (Long Term Evolution), or 5G (Fifth Generation) cellular network connectivity. Other connections may include city-wide WiFi or wireless communications that are specialized for vehicle-to-infrastructure (V2I) or vehicle-to-vehicle (V2V) communications.

As shown in FIG. 3A, vehicles 351-354 communicate with cellular network towers 341-343 or with each other using cellular communications or other V2V communications. Turning to FIG. 3B, in the event of a network outage affecting network tower 343, vehicle 355 is not near a network tower or other vehicles to receive connected vehicle services. This could be because of contextual situations, such as a network outage, weather conditions, road conditions causing traffic disruptions, etc. In accordance with the illustrative embodiment, digital twin simulation and prediction engine 310 predicts the change in contextual situations (e.g., network outage at network tower 343) that would cause vehicle 355 to lose connectivity.

Turning to FIG. 3C, proactive connected vehicle deployment engine 320 deploys an additional connected vehicle 360 in a location between cellular network tower 342 and vehicle 355 or between vehicle 354 and vehicle 355. In response to a change in contextual situations in the real world, proactive connected vehicle deployment engine then activates the additional vehicle 360 to seamlessly provide V2V communications with vehicle 355. The operation of deployment depends on the vehicle being deployed. For autonomous vehicles, such as drones or self-driving vehicles, deployment may comprise sending coordinates or an address to the vehicle with instructions to navigate to the indicated location. For delivery vehicles or rideshare vehicles, deployment may comprise sending an address to an app or navigation system of a driver. Other vehicles may be deployed by sending instructions with a location or address to a driver.

In accordance with the illustrative embodiment, vehicles 351-355 may include passenger vehicles, a fleet of rideshare vehicles, police cars, ambulances, fire trucks, busses, trains, delivery vehicles, trucks, helicopters, drones, or any other vehicles that would benefit from connected vehicle services. In one embodiment, the aspects of the illustrative embodiments apply to non-vehicle connected devices, such as infrastructure, which may include, for example, traffic lights, signage, road markings, pedestrian crossing signals, construction equipment, and the like.

Additional vehicle 360 may be a dedicated vehicle for providing V2V connectivity, which may comprise a car or drone, for example. In one embodiment, the connected vehicle ecosystem may provide locations for cars or drones to park from which the additional vehicles can be activated. In another embodiment, the connected vehicle service provider may have an agreement with rideshare networks to route vehicles to areas where connections may be lost. Thus, rideshare drivers may earn additional money to drive to specified locations when not transporting passengers. Other similar arrangements can be made with other platforms, such as delivery vehicles, delivery drones, autonomous vehicles, etc. Furthermore, FIG. 3C shows a single additional vehicle 360. however, the illustrative embodiment determines a minimum number of additional vehicles that are necessary for providing connected vehicle services, which may include multiple vehicles placed in various locations within the connected vehicle ecosystem.

FIG. 4 is a block diagram of a digital twin simulation and prediction engine in accordance with an illustrative embodiment. Digital twin engine 420 receives real-world sensor data 410 and stores the real-world sensor data in storage 424. Data underpins the digital twin simulation and prediction engine 420. The representation of the real world (model data) is key to modeling the real-world. Real-world sensor data 410 provides the current state of the real world, and the modeling output is generated by the simulations. In accordance with the illustrative embodiment, real-world sensor data 410 includes network availability, weather conditions, road conditions, vehicle conditions, etc.

Network availability data is collected from communication devices within the connected vehicle ecosystem, such as cellular network towers, WiFi hotspots and routers, infrastructure devices, etc. Weather conditions data is collected from weather services that are available through an application programming interface (API). Road conditions data is collected from sensors or from crowdsource reporting. For example, some navigation apps and services allow drivers to report on road conditions. Vehicle conditions data is collected form the vehicles themselves. Vehicle conditions data may include the physical condition of the vehicle itself, such as fuel level, charge level for electric cars or plug-in hybrids, speed, direction, physical sensor data, etc. In one embodiment, vehicle condition data may also include current or scheduled navigation data. Some vehicles connect to a driver's calendar to suggest navigation routes for upcoming appointments. Many electric vehicles modify navigation routes to include charging locations. For trains and busses, the real-world data 410 may include scheduled routes and other data used to manage public transportation.

Digital twin simulation and prediction engine 420 includes digital model 422 and predictive engine 423. Digital model 422 provides now-cast simulation of the connected vehicle ecosystem based on real-time sensor data 424 and physical model data 425. This includes not only each individual connected vehicle but the entire connected vehicle ecosystem. Thus, digital model 422 provides a virtual representation of the real-time counterpart of the connected vehicle ecosystem. This now-cast simulation evolves with the flow of real-time input from sensors.

Predictive engine 423 provides forecast simulation of future states within the connected vehicle ecosystem based on real-world sensor data 424 and physical model data 425. Predictive engine 423 combines now-cast simulation data and historical datasets to perform what-if scenario predictions. Digital model 422 and predictive engine 423 generate modeling output estimated states 426. These modeling output estimated states 426 include contextual situations that may affect connectivity of each connected vehicle within the ecosystem.

Data analysis component 427 performs data analysis on real-world sensor data 424, physical model data 425, and modeling output estimated states 426 to generate insights about what is currently happening and to identify contextual situations that are likely to occur and to affect connected vehicle services. Situational awareness component 421 generates actionable insights and alerts based on the current state of the connected vehicle ecosystem and the predicted changes in contextual situations. Visualization component 428 provides visualization of data and interaction with a user.

Digital twin simulation and prediction engine 420 gathers or collects a vast amount of real-world data, simulates an ecosystem with a large number of connected vehicles, and predicts a vast number of contextual situations. Thus, digital twin simulation and prediction engine 420 provides actionable insights, simulations, and a connected view of the connected vehicle ecosystem. Digital twin simulation and prediction engine 420 uses real-time sensor data to make predictive recommendations through machine learning and artificial intelligence. Simulations can generate huge amounts of data, potentially much more data than the real world can generate. Digital twin simulation and prediction engine 420 creates a virtual representation of complex connected vehicle assets that evolves in real-time, which cannot be achieved manually or using the human mind.

In one illustrative embodiment, in response to predictive engine 423 predicting a change in contextual situations that affect connectivity to connected vehicles, digital model component 422 and predictive engine 423 generate models that add connected vehicles to the ecosystem such that connectivity is restored. Digital model component 422 generates many models with connected vehicles at different locations and stores the models in physical model data 425 and stores the results of the models in modeling output estimated states storage 426. Data analysis component 427 performs data analysis to determine a model from those generated by digital model component 422 that requires the minimum number of additional vehicles to complete connectivity between the connected vehicles. Data analysis component 427 then determines locations for the additional vehicles and predicted timing for activation. Situational awareness component 421 then provides actionable insights such that the additional vehicles can be deployed to the determined locations at the appropriate times.

The digital twin simulation and prediction engine of FIG. 4 may simulate the connected vehicle ecosystem on various levels. For example, the digital twin simulation and prediction engine may simulate every component of the ecosystem, including the functioning of every vehicle, network communication tower, construction equipment, etc. That is, the digital twin simulation and prediction engine may predict when a vehicle may have engine failure or when a network tower will have a power failure. In another embodiment, the digital twin simulation and prediction engine may simulate components at a higher level while simulating the ecosystem as a whole. The level of granularity will depend on the amount of computing resources available, the level of service promised to the customers, the complexity of the ecosystem, etc.

FIG. 5 is a block diagram illustrating a digital twin architecture in accordance with an illustrative embodiment. A digital twin simulation and prediction engine is not a stand-alone application. The digital twin architecture integrates into the connected vehicle services platform to collect real-time data and to make predictive recommendations regarding deploying connected vehicles into the ecosystem to ensure that connected vehicle services are provided successfully.

The digital twin simulation and prediction engine includes the real world 501 and seven layers of information management and manipulation. These layers include process management 511, visualization 512, analytics and artificial intelligence 513, simulation modeling 514, systems of record 515, data 516, and an Internet-of-Things (IoT) stack 517. The digital twin simulation and prediction engine also includes integration 521, governance 522, and security 523, which ensure the digital twin is secured, appropriately coupled, and governed to ensure accuracy and quality of data.

The real world 501 includes people, places, devices, assets, content, processes, and organizations. People may include drivers, passengers, pedestrians, and workers. Places may include the locations of connected vehicles and infrastructure. Devices may include the connected vehicles, network towers, infrastructure, and the like. Assets may include connected vehicles that can be deployed or moved to provide connected vehicle services. Content may include information and entertainment consumed by drivers and passengers in the connected vehicles. Processes may include activities performed to provide or to consume the connected vehicle services. Organizations may include the connected vehicle services provider, public transportation services, ridesharing services, delivery services, and the other organizations that are part of or interface with the connected vehicle ecosystem.

Process management 511 may include business process models, workflow, simulation tools, resource allocation, and prioritization. Visualization 512 may include, for example, human readable/interpretable visualizations, abstract representations, geometric representations, physical re-imaging, two-dimensional or three-dimensional representations, augmented reality (AR) or virtual reality (AR) representations, a real-time dashboard, alerts, etc. Analytics and Al 513 may include statistical representation, descriptive or diagnostic analysis, predictive analysis, optimizations, management information system (MIS) decision making, deep machine learning (ML), predictive maintenance, pattern recognition, feature extraction, and event pattern identification. Simulation modeling 514 includes multi-dimensional predictive models, stochastic simulation, deterministic simulation, process simulation, Monte Carlo simulation, discrete event simulation, mathematical representation, function simulation, and production of unseen states. Systems of record 515 may include, for example, enterprise resource planning (ERP), computer aided design (CAD), enterprise architecture management (EAM), product lifecycle management (PLM), global information system (GIS), configuration management database (CMDB), and requirements. Data 516 may include archiving, schemas, aggregation, weather data, vehicle data, road conditions, infrastructure data, states (current and historic), simulation test data, external sources, etc. IoT stack 517 may include sensors, real-world data, communications, IoT platform etc.

Integration 521 includes process, API management, simulation couplers, applications, enterprise service bus (ESB), data, protocols, networks, etc. Governance 522 includes data lifecycle, data access control, master data management, simulation input and output version control, data catalogue, model governance, interfaces, ethics, and standards. Security 523 includes perimeter (loT sensor data), data security and privacy, intrusion detection, identity and access management, encryption, endpoint management, and device identity.

The digital twin simulation and prediction engine of the illustrative embodiment is not a product that can be purchased over the counter. Instead, the digital twin simulation and prediction engine is specifically configured, designed, and trained to represent the connected vehicle ecosystem and to predict changes in contextual situations. The digital twin simulation and prediction engine is a result of significant systems integration.

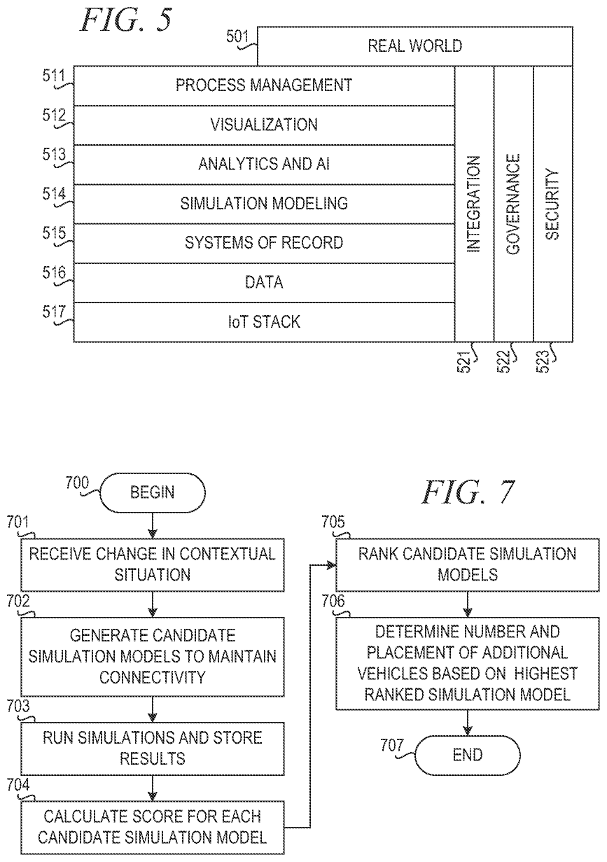

FIG. 6 is a flowchart illustrating operation of a connected vehicle service provider system for proactive deployment of connected vehicles to a connected vehicle ecosystem based on computerized simulation and prediction of contextual situations in accordance with an illustrative embodiment. Operation begins block 600), and the connected vehicle service provider system uniquely identifies each vehicle in the connected vehicle ecosystem (block 601). The connected vehicle service provider system identifies types of services provided by the connected vehicle service provider (block 602). The types of services provided may be identified in one or more blockchain ledgers that enforce agreements between the connected vehicle service provider and customers.

The connected vehicle service provider system gathers or collects real-time data from each vehicle, traffic, weather, network, etc. (block 603). As mentioned above, the real-time data may include network availability, weather conditions, road conditions, vehicle conditions, etc. The connected vehicle service provider system simulates services provided to vehicles using a digital twin simulation and prediction engine (block 604). The digital twin simulation and prediction engine uses a model of the connected vehicle ecosystem and the gathered real-time data to simulate a current real-world instance of the connected vehicle ecosystem and also predicts future contextual situations. While shown as ordered steps in blocks 603 and 604, in one illustrative embodiment, the digital twin simulation and prediction engine continuously gathers real-time data and simulates services provided to vehicles such that changes in contextual situations can be predicted in the simulations and detected in the real world at any time.

Thus, the connected vehicle service provider system predicts changes in contextual situations within the connected vehicle ecosystem (block 605). For example, the digital twin simulation and prediction engine can predict changes in weather, road conditions, vehicle conditions, and network connectivity. The connected vehicle service provider system determines whether a predicted change in contextual situation affects services provided to the connected vehicle customers (block 606). A primary change in contextual situation that would affect services is loss of network connectivity. Other changes that could affect services may include changes in weather that would block satellite communications, rerouting of traffic due to construction or an accident, and the like. If the connected vehicle service provider system does not predict a change in contextual situation that affects connected vehicle services, then operation returns to block 603 to continue gathering real-time data and simulating the services provided to vehicles.

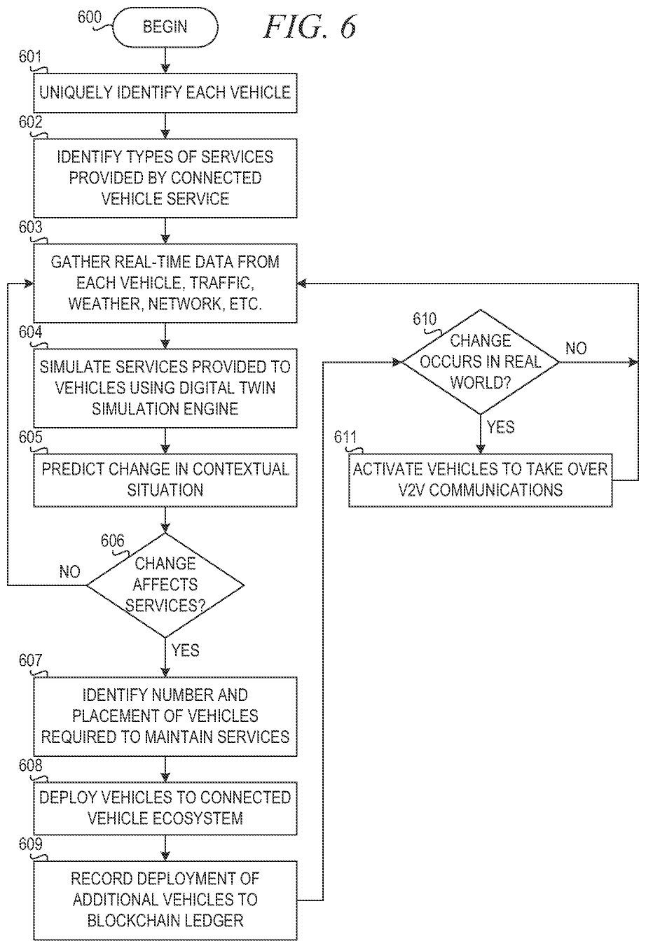

If the connected vehicle service provider system determines that a predicted change in contextual situation affects services in block 606, then the connected vehicle service provider system identifies a number and placement of vehicles required to maintain services (block 607). The operation of the connected vehicle service provider system to identify the number and placement of vehicles to maintain services is described in further detail below with reference to FIG. 7. The connected vehicle service provider system then deploys additional vehicles to the connected vehicle ecosystem based on the identified number and placement (block 608). The connected vehicle service provider system records the deployment of the additional vehicles to the one or more blockchain ledger (block 609).

Next, the connected vehicle service provider system determines whether predicted changes actually occur in the real world based on the gathered real-time data (block 610). If the predicted changes do not occur in the real world, then operation returns to block 603 to continue gathering real-time data and simulating the services provided to vehicles. If the connected vehicle service provider system determines that a predicted change to contextual situation that affects services occurs in the real world in block 610, then the connected vehicle service provider system activates the additional vehicles to take over vehicle-to-vehicle communications to maintain the connected vehicle services (block 611). Thereafter, operation returns to block 603 to continue gathering real-time data and simulating the services provided to vehicles.

FIG. 7 is a flowchart illustrating operation of a connected vehicle service provider system identifying a number and placement of additional vehicles required to maintain services in accordance with an illustrative embodiment. Operation begins (block 700), and the connected vehicle service provider system receives a change in contextual situation that affects connected vehicle service (block 701). The connected vehicle service provider system generates candidate simulation models to maintain connectivity (block 702). The candidate models may be generated by considering a range of V2V communication of each vehicle in the connected vehicle ecosystem to determine areas where connectivity is lost. The connected vehicle service provider system may generate a plurality of candidate models based on different placement methodologies. For example, the connected vehicle service provider system may have one methodology based on a center of an area of lost connectivity and another methodology based on a “center of gravity” based on a density of vehicles affected by the loss of connectivity. Other methodologies may be used based on level of service promised to the customers, type of contextual situation that has changed, type of service affected, type of additional vehicles that are available be deployed, possible future flows of traffic, etc.

The connected vehicle service provider system runs the simulations of the plurality of candidate simulation models and stores results of the simulations (block 703). The connected vehicle service provider system then calculates a score for each candidate simulation model (block 704) and ranks the candidate simulation models by score (block 705). The models may be scored and ranked based primarily on the number of additional vehicles needed. In some example embodiments, other metrics may also be used for scoring. For example, the candidate models may be scored based on the number of miles traveled by the additional vehicles, the amount of energy consumed by the additional vehicles to arrive at their determined positions or locations, the cost to deploy the additional vehicles, the types of additional vehicles needed, etc. Thereafter, the connected vehicle service provider system determines the number and placement of additional vehicles based on the highest ranked simulation model (block 706), and operation ends (block 707).

Thus, the illustrative embodiments provide mechanisms for simulating services of connected vehicles in different contextual situations and proactively arranging a required number of vehicles in the connected vehicle ecosystem. In any connected vehicle ecosystem, each and every vehicle is identified uniquely and gathers travel details of the vehicles. The mechanisms of the illustrative embodiments gather real-time data from the vehicles and create digital twin models of the vehicles. The mechanisms identify the types of services that are agreed upon with the customers and analyzes each service and simulates the services using the digital twin models. Based on the digital twin simulation, the mechanisms of the illustrative embodiments identify a required number of vehicles and locations to maintain the connected vehicle services.

The mechanisms of the illustrative embodiments also simulate contextual situations and use a historical knowledge corpus to predict different contextual situations that can disrupt connected vehicle service. The mechanisms predict changes in the contextual situations, a degree of change, location and timing of the changes, and when additional connected vehicles are required. Based on the predicted degree of change, the mechanisms of the illustrative embodiments identify a minimum number of additional vehicles required to provide the connected vehicle service. The mechanisms deploy the vehicles to the determined locations. For example, the mechanisms may make the required vehicles available in parking lots or other locations such that the vehicles can be added to the connected vehicle ecosystem when they are required.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication-based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for proactive deployment of connected vehicles to a connected vehicle ecosystem based on computerized simulation and prediction of contextual situations, the method comprising:
collecting real-world data from sensors in a connected vehicle ecosystem;
simulating the connected vehicle ecosystem based on the real-world data and simulation model data of the connected vehicle ecosystem;
predicting changes in contextual situations in the connected vehicle ecosystem that affect connected vehicle services provided in the connected vehicle ecosystem based on the simulation of the connected vehicle ecosystem, the real-world data, and the simulation model data;
identifying a number of connected vehicles required to provide the connected vehicle services;
deploying one or more additional connected vehicles to the connected vehicle ecosystem based on the predicted changes in contextual situations and the minimum number of connected vehicles required to provide the connected vehicle services.

2. The method of claim 1, wherein the real-world data comprises network availability, weather conditions, road conditions, and vehicle conditions.

3. The method of claim 1, wherein simulating the connected vehicle ecosystem comprises generating a now-cast simulation of the connected vehicle ecosystem using a digital twin simulation and prediction engine.

4. The method of claim 3, wherein predicting changes in contextual situations in the connected vehicle ecosystem comprises generating forecast simulations of the connected vehicle ecosystem based on the now-cast simulation using the digital twin simulation and prediction engine.

5. The method of claim 1, wherein the changes in contextual situations in the connected vehicle ecosystem that affect connected vehicle services provided in the connected vehicle ecosystem comprise unavailability of a wireless network providing communications to one or more vehicles in the connected vehicle ecosystem.

6. The method of claim 1, wherein identifying the number of connected vehicles required to provide the connected vehicle services comprises:
for a given change in contextual situation, generating a plurality of candidate simulation models to maintain connectivity in the connected vehicle ecosystem;
running a plurality of simulations for the plurality of candidate simulation models and storing results of the plurality of simulations;
calculating a score for each of the plurality of candidate simulation models;
ranking the plurality of candidate simulation models according to the calculated scores; and
identifying a number of additional vehicles required based on the highest ranked candidate simulation model.

7. The method of claim 6, wherein generating the plurality of candidate simulation models comprises generating candidate simulation models according to a plurality of methodologies.

8. The method of claim 6, wherein the score is calculated based on the number of additional vehicles required to provide the connected vehicle services.

9. The method of claim 6, further comprising identifying placement of the additional vehicles based on the highest ranked candidate simulation model.

10. The method of claim 1, further comprising:
identifying the connected vehicle services provided in the connected vehicle ecosystem based one or more blockchain ledgers that enforce an agreement between a connected vehicle service provider and one or more customers; and
recording the deployment of the one or more additional connected vehicles to the connected vehicle ecosystem in the one or more blockchain ledgers.

11. A computer program product comprising a computer readable storage medium having a computer readable program stored therein for proactive deployment of connected vehicles to a connected vehicle ecosystem based on computerized simulation and prediction of contextual situations, wherein the computer readable program, when executed on a computing device, causes the computing device to:
collect real-world data from sensors in a connected vehicle ecosystem;
simulate the connected vehicle ecosystem based on the real-world data and simulation model data of the connected vehicle ecosystem;
predict changes in contextual situations in the connected vehicle ecosystem that affect connected vehicle services provided in the connected vehicle ecosystem based on the simulation of the connected vehicle ecosystem, the real-world data, and the simulation model data;
identify a number of connected vehicles required to provide the connected vehicle services;
deploy one or more additional connected vehicles to the connected vehicle ecosystem based on the predicted changes in contextual situations and the minimum number of connected vehicles required to provide the connected vehicle services.

12. The computer program product of claim 11, wherein the real-world data comprises network availability, weather conditions, road conditions, and vehicle conditions.

13. The computer program product of claim 11, wherein simulating the connected vehicle ecosystem comprises generating a now-cast simulation of the connected vehicle ecosystem using a digital twin simulation and prediction engine.

14. The computer program product of claim 13, wherein predicting changes in contextual situations in the connected vehicle ecosystem comprises generating forecast simulations of the connected vehicle ecosystem based on the now-cast simulation using the digital twin simulation and prediction engine.

15. The computer program product of claim 11, wherein the changes in contextual situations in the connected vehicle ecosystem that affect connected vehicle services provided in the connected vehicle ecosystem comprise unavailability of a wireless network providing communications to one or more vehicles in the connected vehicle ecosystem.

16. The computer program product of claim 11, wherein identifying the number of connected vehicles required to provide the connected vehicle services comprises:
for a given change in contextual situation, generating a plurality of candidate simulation models to maintain connectivity in the connected vehicle ecosystem;
running a plurality of simulations for the plurality of candidate simulation models and storing results of the plurality of simulations;
calculating a score for each of the plurality of candidate simulation models;
ranking the plurality of candidate simulation models according to the calculated scores; and
identifying a number of additional vehicles required based on the highest ranked candidate simulation model.

17. The computer program product of claim 16, wherein generating the plurality of candidate simulation models comprises generating candidate simulation models according to a plurality of methodologies.

18. The computer program product of claim 16, wherein the score is calculated based on the number of additional vehicles required to provide the connected vehicle services.

19. The computer program product of claim 16, wherein the computer readable program further causes the computing device to identify placement of the additional vehicles based on the highest ranked candidate simulation model.

20. An apparatus for proactive deployment of connected vehicles to a connected vehicle ecosystem based on computerized simulation and prediction of contextual situations, the apparatus comprising:
a processor; and
a memory coupled to the processor, wherein the memory comprises instructions which, when executed by the processor, cause the processor to:
collect real-world data from sensors in a connected vehicle ecosystem;
simulate the connected vehicle ecosystem based on the real-world data and simulation model data of the connected vehicle ecosystem;
predict changes in contextual situations in the connected vehicle ecosystem that affect connected vehicle services provided in the connected vehicle ecosystem based on the simulation of the connected vehicle ecosystem, the real-world data, and the simulation model data;
identify a number of connected vehicles required to provide the connected vehicle services;
deploy one or more additional connected vehicles to the connected vehicle ecosystem based on the predicted changes in contextual situations and the minimum number of connected vehicles required to provide the connected vehicle services.
